(19) United States
(12) Patent Application Publication
(10) Pub. No.: US 2007/0110637 A1
(43) Pub. Date: May 17, 2007

(54) Automated rotary synthesizer

(76) Inventor: David Y. Phelps, Louisville, KY (US)

Correspondence Address: STITES & HARBISON, PLLC, 400 W MARKET ST, SUITE 1800, LOUISVILLE, KY, 40202-3352, US

(21) Appl. No.: 11/372,818

(22) Filed: Mar. 10, 2006

Related U.S. Application Data
(60) Provisional application No. 60/735,276, filed on Nov. 11, 2005.

(51) Int. Cl. B01J 19/00

(52) U.S. Cl. 422/130

(57) ABSTRACT

An automated synthesizer is disclosed in which the reaction wells are moved by a carousel into alignment with stationary nozzles that are in communication with the source of reactants and/or washing solutions. By moving the wells rather than moving the nozzles for the delivery of reagents and washing solutions, the amount of time required to introduce reagent is substantially reduced.

This application claims the benefit of the filing date of provisional application Ser. No. 60/735,276, entitled AUTOMATED ROTARY SYNTHESIZER which application is incorporated by reference herein.

### FIELD OF THE INVENTION

This invention relates to automated chemical synthesizers and more particularly to improved automated rotary chemical synthesizer.

### BACKGROUND OF THE INVENTION

The production of chemicals and biochemicals and products such as, for example, peptides, proteins, carbohydrates and DNA and genetic material has been simplified with the advent of synthesizers which automatically or semi-automatically carry out the stepwise addition of reagents and carry out reactions, such as the synthesis of peptides, or for carrying out fragment coupling reactions. Conventionally, fully automated synthesizers include a robotic arm that carries a vertically moveable probe for travel between a source of reagents and individual reaction wells in which the reaction occurs.

The automated synthesizers relying on robotic arms to transfer reagents exhibit several deficiencies. One deficiency is that the robotic arm moves slowly and must make a large number of moves, depending on the number of reactants in the finished product, between the source of reagent, wash solution and the reaction wells thus requiring a substantial amount of time for reagent delivery, particularly when carrying out a large number of reactions in a single block. The use of a single probe on the robotic arm can result in contamination as the probe handles more than one reagent. In addition such synthesizers can require a high level of maintenance to insure the correct calibration of the robotic arm to insure precise alignment with each reaction well. Conventional synthesizers rely on an agitator for mixing of the reagents in the reaction wells. This agitation coupled with the conventional configuration of the reaction wells can result in splash out of material and contamination between adjacent wells of the block.

### SUMMARY OF THE INVENTION

According to the present invention improved automated synthesizers are provided in which reagents are delivered to reaction wells precisely and at a faster rate than for the synthesizers that utilize a robotic arm. The automated synthesizer of the invention is reliable and economical. In addition, cross-contamination is essentially eliminated as the injection nozzle does not travel in horizontal and vertical directions over a reaction well as is the case for synthesizers employing a robotic arm. Reagents are dispensed directly into the reaction well from containers and dispensing nozzles that are dedicated to a single reagent so the fluid path for each reagent does not come into contact with any other reagent, eliminating another area of contamination.

In accordance with the present invention, there is provided an improved automated synthesizer in which the reaction wells are moved into alignment with stationary nozzles that are in communication with the source of reactants and/or washing solutions. By moving the wells rather than moving the nozzles for the delivery of reagents and washing solutions, the amount of time required to introduce reagent is substantially reduced. The number of washing steps required is reduced since a single dispensing nozzle delivers only one reagent so that a washing step is eliminated when a different reagent is to be delivered to a reaction well. The danger of cross-contamination due to the movement of a dispensing nozzle over the reaction block that can give rise to the possibility of small amounts of reagent from the nozzle gaining access into other reaction wells. Also contamination is eliminated since a separate injector nozzle dispenses one reagent only. In addition, the agitation of the reaction block is eliminated and improved mixing of reactants is achieved by the configuration of the reaction wells and by the movement of the reaction wells as they are brought into alignment with a reagent nozzle or a wash fluid nozzle.

More particularly, in one embodiment the automated synthesizer comprises a rotatable carousel having at least one reaction well disposed at the periphery of the rotatable carousel. A reaction well includes a reaction chamber and an injection port. Preferably a reaction well includes an access port for an inert gas and a drain port for emptying the well. Rotation of the carousel brings at least one of the reaction wells into alignment with a dispensing nozzle of a stationary delivery system for delivery of reagent into the reaction chamber of the reaction well. A reversible stepper motor powers the rotatable carousel for rotation in either direction.

In a preferred embodiment the stationary delivery system comprises at least one reagent station comprising a container for reactants and a dispensing nozzle that is in fluid communication with the reactant in the container. In one embodiment a syringe is activated to draw reagent from the container and to dispense a controlled amount of reagent through the dispensing nozzle into the reaction chamber. A stationary wash station and drain system includes a plurality of wash injectors that are in fluid communication with one or more wash fluids. One or more linear activators are provided to lower the wash nozzles into the reaction wells for an essentially pressure tight seal and to raise the nozzle for clearance during rotation of the carousel. A frame member in the housing supports the reactant containers and wash fluid containers. While the invention is described herein in connection with a syringe and plunger it should be understood that other commercially available alternative injection systems can be employed with good results. For example, the confluent pump and valve module distributed by Sapphire Engineering, Pocasset Mass. can be used with equal results.

A control system including a CPU, keyboard and monitor are provided for programming and controlling the sequence of reactions and washing steps carried out by the automated synthesizer. Pulses of nitrogen gas are introduced into the reaction chamber to purge the liquid portion out of the container through the drain port for disposal or for collection. The drain port includes a suitable device to maintain solids such as solid support resins in the reaction chamber. Such a device may include a filter, a mechanical valve (check, duckbill or pinch) with set cracking pressure, an electronically controlled solenoid valve, or a vertical trap.

In one embodiment of the invention, the stationary delivery system includes one or more removable cartridges that contain reactant and other liquids required for the reaction. A dispensing nozzle is also associated with the cartridge so that each cartridge of the delivery system is self-contained. In yet another embodiment of the invention, a suitable sensor is provided to indicate the level of reactant in the cartridge.

The embodiments of the invention described herein have found utility in peptide formation and other solid phase and liquid phase chemical reactions can be performed using the synthesizer of the present invention.

### DESCRIPTION OF THE DRAWINGS

FIG. 1 is a schematic diagram of an automated synthesizer designed in accordance with the present invention;

FIG. 2 is a perspective view of one embodiment of the invention;

FIG. 3 illustrates portion of the carousel platform carrying the reaction wells;

FIG. 4 illustrates the carousel platform support and drive system;

FIG. 5 is an exploded view of a segment of the carousel showing reaction cavities and reaction wells;

FIG. 6 is a side sectional view of a reaction well;

FIG. 7 is a perspective view of the reagent delivery and wash stations of the synthesizer of the invention;

FIG. 8 is a top plan view of an embodiment of the invention showing six reagent or wash fluid delivery stations;

FIG. 9 is a side sectional view of a station for delivery of reagent or wash fluid to a reaction well;

FIG. 10 illustrates the front elevation of a cartridge adapted for use at a wash station;

FIG. 11 is a side elevation of the cartridge of FIG. 10;

FIG. 12 is a side sectional view of another embodiment of a reaction well;

FIG. 13A is a top plan view of the carousel showing reaction wells oriented with their long dimensions normal to the carousel axis of rotation;

FIG. 13B is a top plan view of the carousel showing reaction wells oriented with their long dimensions disposed at an angle to the carousel axis of rotation; and

FIG. 14 is a sectional view, partially broken away for compactness of illustration, showing a collection vessel and its attachment to a carousel.

### DESCRIPTION OF THE INVENTION

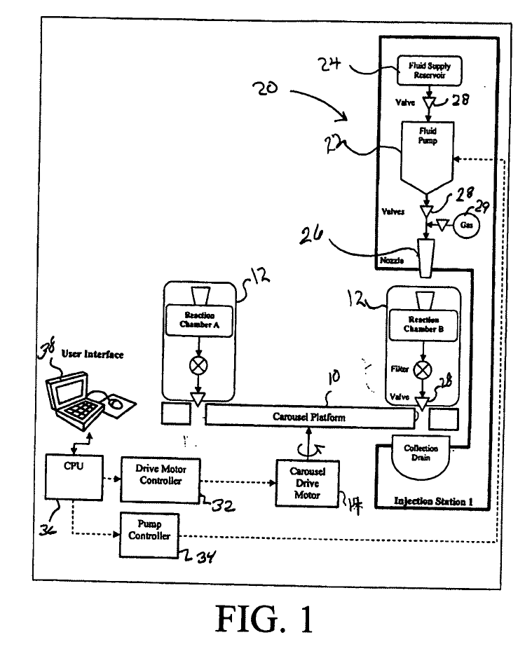

Referring to FIG. 1 there is illustrated in schematic form an automated chemical synthesizer in accordance with the present invention. A rotatable carousel 10 carrying reaction wells 12 is drivingly engaged to a drive motor 14 for moving at least one of the reaction wells into alignment with a stationary reagent delivery station, shown generally as 20. The reagent delivery station includes a fluid pump 22 that is in fluid communication with a reservoir 24 and a dispensing nozzle 26. Valves 28 are provided to insure one-way flow from the reservoir 24 through the pump 22 to the nozzle 26 and from the reaction wells 12 to a collection drain 40 for collecting spent reagent. A source 29 of inert gas communicates with the nozzle for providing an inert atmosphere in the reaction well 12 and for aid in emptying the reaction well.

A control system includes a drive motor controller 32 for control of the drive motor 14 and a pump controller 34 for activation of the fluid pump 22. Both of the controllers, 32 and 34, are in communication with a central processing unit (CPU) 36 for receiving protocol commands. A user interface 38 is provided for input of commands to the CPU 36.

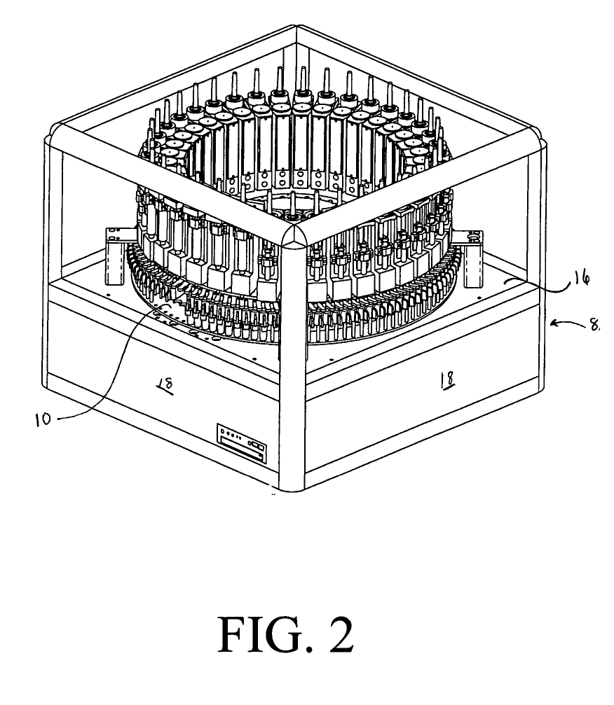

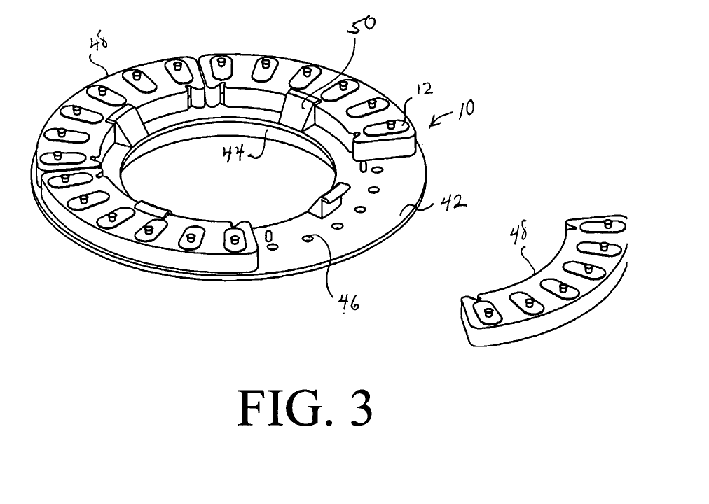

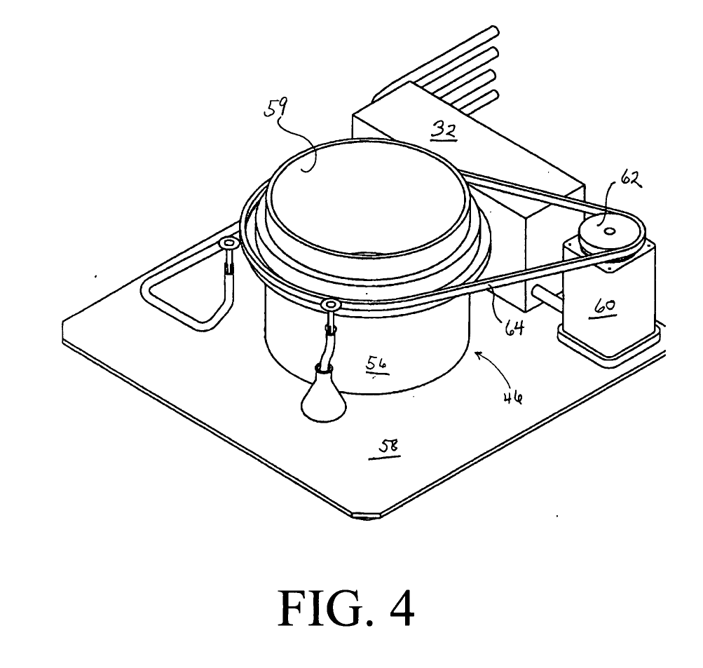

Referring to FIG. 2 and FIG. 3, a housing 8 is provided having a top wall 16, a base mounting plate 58 (FIG. 4) and front, rear and side walls 18 which cooperate to define an interior in which the drive motor 14, the drive motor controller 32 and the pump controller 34 are disposed. The CPU 36 can also be located in the housing 8 or alternatively the CPU can be located on the exterior of the housing and communicate with the controllers 32 and 34 by cable or wireless communication. In the embodiment illustrated the rotatable carousel 10 comprises an annulus 42 (FIG. 3) having a downwardly extending ring 44 about its inner circumference. The annulus 42 is provided with a plurality of openings 46 for communication between a reaction well 12 and the collection drain 40. As illustrated four arcuate segments 48 are removably secured on the annulus 42 by clamping brackets 50. As most clearly shown by FIG. 4, a series of reaction well cavities 52 are formed in the segment 48 for receiving corresponding reaction wells 12 and the cavities are provided with corresponding openings 54 which are aligned with the openings 46 in the annulus 42. It will be understood that the number of arcuate segments 48 as well as the number of reaction wells 12 can be varied and modified as desired depending on such factors as, for example, the desired quantity of finished product, the number of different products to be prepared, the complexity of the reactions being carried out and other factors well understood by those skilled in the art. The carousel may contain reaction wells of different volume simultaneously.

One embodiment that exemplifies a system for driving the carousel 10 is the offset driving system illustrated in FIG. 4. A carousel mount, shown generally as 46 consists of a fixed cylindrical outer sleeve 56, carried on the base mounting plate 58. Concentrically disposed in the outer sleeve 56 is a rotatable inner sleeve 59 having an open end that extends above the outer sleeve. The ring 44 of the annulus 42 is fit within the mouth of the inner sleeve for attachment of the annulus to the inner sleeve for rotation therewith. Bearing assemblies (not shown) are provided within the outer sleeve 56 for essentially friction free rotation of the inner sleeve 59 and to absorb forces imposed on the inner sleeve as the carousel 10 is being driven. A stepper motor 60 is mounted on the mounting plate 58. A pulley 62 driven by the stepper motor 60 is drivingly connected to the inner sleeve 58 by a belt 64. The stepper motor 60 is capable of driving the carousel 10 in either direction. The drive motor controller 32 is electronically connected to the stepper motor 60 for controlling the rotation of the carousel 10 through the stepper motor. It will be understood that other systems for driving the carousel, can be employed equally as well, for example, by connecting the carousel 10 directly to the motor 60 so long as the driving system is capable of driving the carousel in either direction. A collection drain 40 and ancillary lines are also supported on the base mounting plate 58.

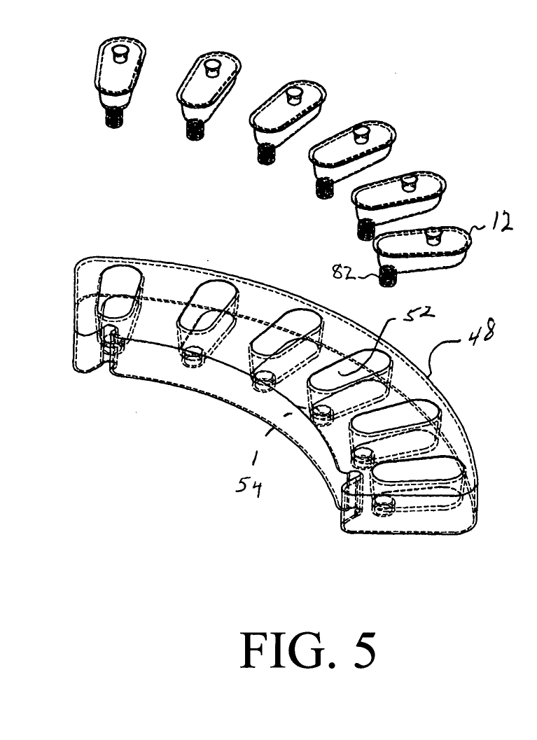

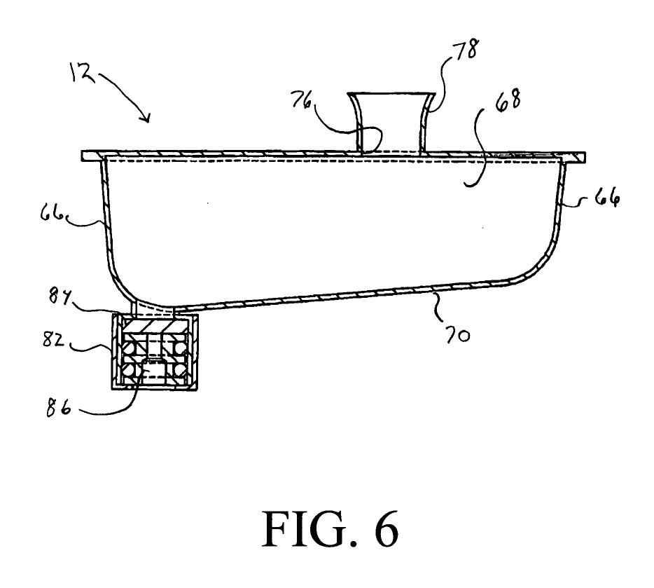

Preferably, as is shown in FIG. 5, the reaction wells 12 are removable from the reaction well cavities 52 and can be disposable. Referring to FIG. 6 the reaction well 12 comprises end walls 66, sidewalls 68, a bottom wall 70 and a closure 72 that cooperate to form a reaction chamber 74. The closure 72 is provided with an inlet port 76 that is surrounded by an upstanding collar 78 for receiving the discharge end of the dispensing nozzle 26 during delivery of reactants to the reaction chamber 74. Likewise, the bottom wall 70 has a drain opening 80 that communicates with a collection drain 40 for removal of reactant. Surrounding the outlet of the drain opening 80 is a housing 82 in which is located a filter element 84 and a valve 86 to prevent the back flow of drained reactant back into the reaction chamber 74. Valve 86 also is designed to open when pressure in the reaction well 12 reaches a pre-selected level during flushing of the reaction chamber under pressurized inert gas.

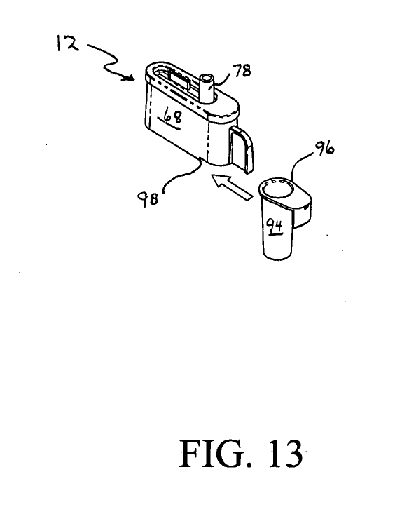

In a preferred embodiment the bottom wall 70 of the reaction well 12 slopes downwardly toward the drain opening 80. The angle of slope may range from between about 1° to about 45°, preferably between about 5° and about 30° from the horizontal. This allows fluids to collect at the drain opening 80 which facilitates their removal from the reaction well. As illustrated, the longitudinal dimension of the reaction well 12 is greater than its transverse dimension. Mixing and agitation of reagents in the reaction well 12 without the necessity of a separate agitator is achieved by the orientation of the wells on the carousel 10. As shown in FIG. 13A the reaction wells 12 are oriented with their longitudinal dimensions normal to the axis of rotation of the carousel 10. Even more agitation is achieved by another embodiment, illustrated in FIG. 13B, where the reaction wells 12 are positioned so that the longitudinal dimension is oriented at an angle to the axis of rotation of the carousel 10. Thus the reaction well 12 may be oriented on the carousel 10 so that the longitudinal dimension ranges between 0° to about 90° to the axis of rotation of the carousel. Preferably the reaction wells 12 are oriented with their longitudinal dimension is between about

As shown in FIG. 5 the housing 82 in which the filter 84 and valve 86 is formed as part of the reaction well 12. Alternatively, the housing 82 may be removably attached to the reaction well or attached to the annulus 42 at each of the openings 46 in the event the reaction wells are to be disposable.

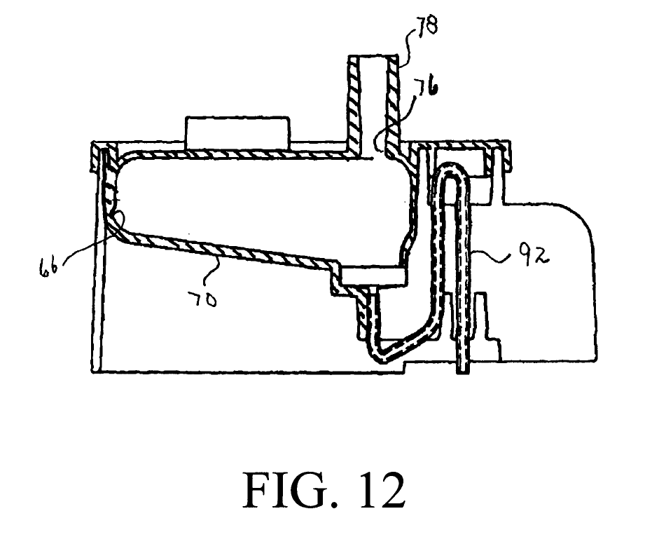

Another embodiment of the reaction well 12 is shown in FIG. 12 where like reference numbers denote like parts and functions. An inverted U-shaped tube 92 communicates between the reaction chamber 74 and the drain opening 80. The inverted U-shaped tube 92 forms a trap to prevent back flow of drained reactant into the reaction chamber 74.

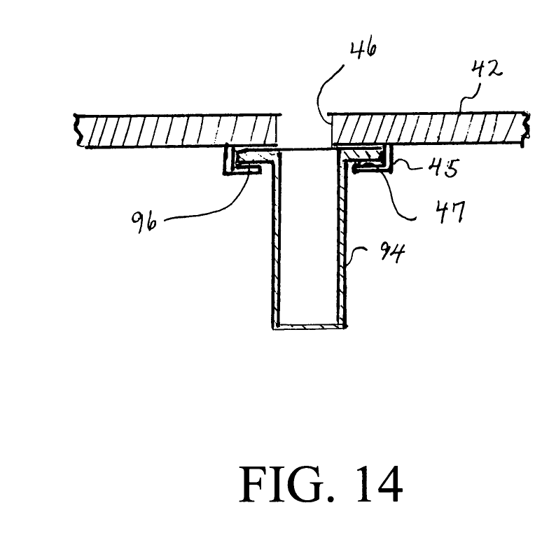

When carrying out solid phase reactions the final step necessary to recover the end product is the step of cleaving the product from the solid phase. This is similar to a washing step except that the liquid from the reaction well 12 must be recovered rather than sent to waste. A recovery vessel can be aligned with the drain opening 80 from a reaction well 12 to recover the product along with the cleavage fluid. In one embodiment, carousel 10 can be adapted for conveniently capturing cleavage fluid and the final product by attachment of a recovery container to the annulus 42. As illustrated in FIG. 14, where like reference numbers denote like parts and like functions, an opposed pair of L-shaped brackets 47 are disposed on the undersurface of the annulus 42 on opposite sides an opening 46 with their horizontal arms facing one another. A removable recovery container 94 is provided with a flange 96 formed about its mouth. The recovery container 94 is supported by the flange 96 and the brackets 47 with the container mouth aligned with a corresponding opening 46. A stop (not shown) may be disposed on the annulus 42 to limit the insertion of the flange 96 of the recovery container 94 to insure its mouth is aligned with the corresponding opening 46. Alternatively, the recovery container 94 may be attached to the housing 82 of the reaction well 12 of the type shown in FIG. 6 by bayonet lug attachment points (not shown) on the housing and the inner surface of the recovery container adjacent its mouth.

Reagents are controllably dispensed to the reaction chamber 74 at a delivery station 20. Similarly, the reaction chamber 74 is washed with a suitable washing fluid at a wash station similar to the delivery station 20. The number and arrangement of the delivery and wash stations varies depending on the complexity and the number of steps in the reaction protocol being carried out.

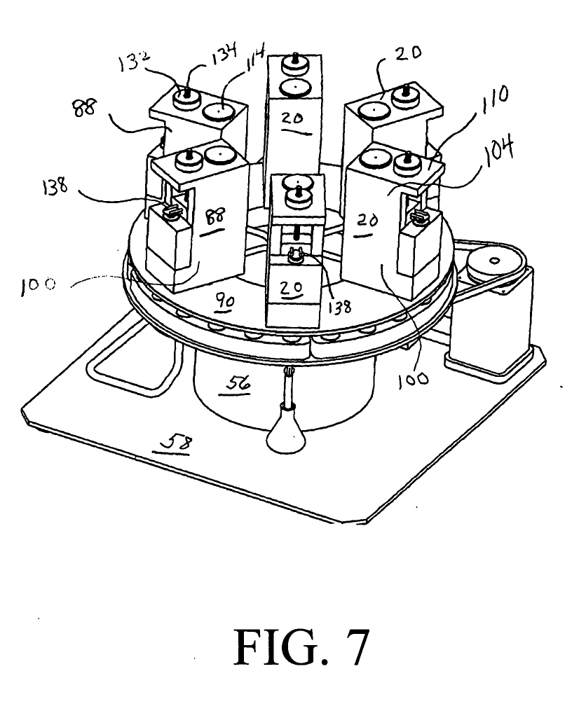

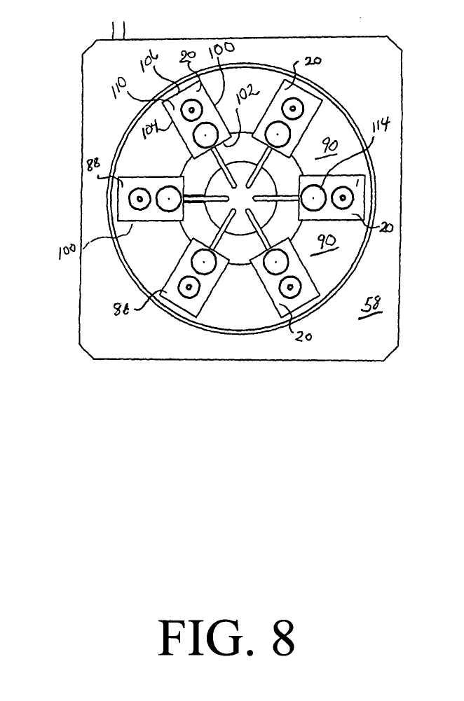

In FIG. 7 and FIG. 8 there are illustrated six stations of which four are delivery stations 20 and two are wash stations 88. The stations 20 and 88 are mounted on a fixed platform 90 above the carousel 10. The fixed platform 90 is carried by supports 91 in the housing 8 in which the components of the synthesizer are contained. During a sequence of protocol steps rotation of the carousel moves the inlet port 76 of a reaction well 12 into alignment with the nozzle 26 of a desired station containing the particular reagent called for at that step of the protocol. When the protocol calls for a washing step the carousel is rotated to bring the inlet port 76 of the reaction well 12 into alignment with the nozzle 26 of the wash fluid station. Positioning of the carousel at the proper angular position is directed by the drive motor controller 32 that receives commands from the CPU 36 (FIG. 1).

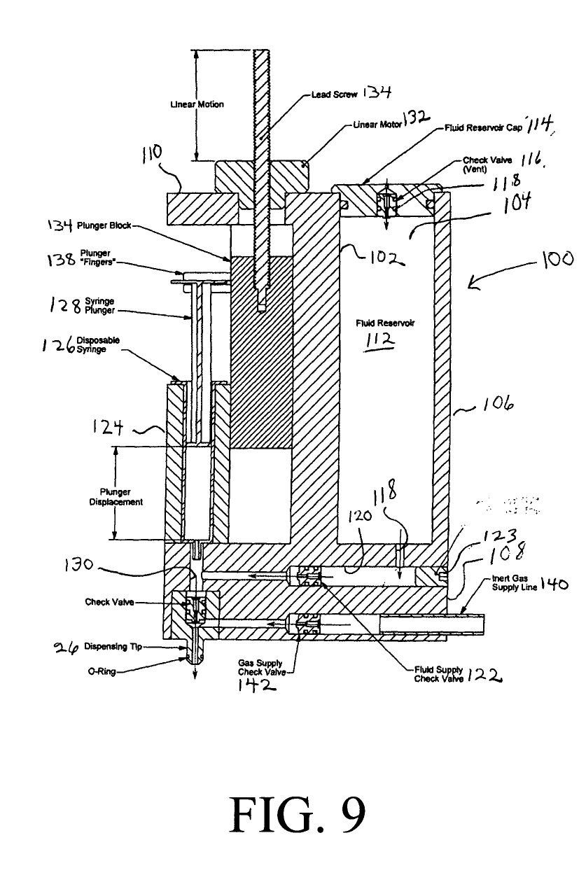

As shown in FIG. 9 the reagent delivery station 20 and wash station 88 comprise cartridges 100, having a front wall 101, side walls 104, a rear wall 106 a bottom wall 108 and a top wall 110, the inner surfaces of which cooperate to define a reservoir 112. The top wall 110 is open at the mouth of the reservoir 112 and a closure 114 normally seals the reservoir mouth. A check valve 116 is disposed in an opening 118 in the closure 114 prevent vapors from leaving the reservoir 112 and to allow air into the reservoir 112 to Valve to displace the withdrawn fluid volume. The bottom wall 108 is extended past the front wall 102 and an upwardly extending member 124 having a through running bore 125 receives a syringe 126 and a syringe plunger 128. Preferably the syringe 126 and plunger 128 are disposable.

A fluid port 118 in the bottom wall 108 communicates between the reservoir 112 and a fluid supply line 120 that opens to the rear wall and extends through the bottom wall to a fluid dispensing line 130 that communicates between the syringe 126 and the dispensing nozzle 26. A check valve 122 is disposed in the fluid supply line 122 and a plug 123 normally seals the opening of the fluid supply line at the rear wall 106 of the cartridge 100.

The top wall 110 extends beyond the front wall and a linear motor 132 is mounted thereon. A lead screw 134 operated by the linear motor for bi-directional vertical movement extends through the top wall. The extending end of the lead screw 134 carries a plunger block that, responsive to the vertical movement of the lead screw, slides vertically along the outer surface of the front wall 102. A spaced apart upper and lower pair of fingers 138 extend from the face of the plunger block 136 and the flange of the syringe plunger 128 is received the upper and lower pair for the vertical movement of the plunger responsive to the vertical movement of the plunger block. The linear motor is in electrical communication with the pump controller 34 for control of the vertical movement of the plunger block and resultant operation of the syringe 126 through control of the linear motor.

An inert gas supply line 140 extends through the bottom wall 108 for communication between a source of inert gas (not shown) and the fluid dispensing line 130 for introduction of an inert gas into a reaction well 12. A check valve 142 in the inert gas supply line 140 prevents a back flow from the dispensing line 130 to the source of inert gas.

The cartridge 100 operates in the same fashion as a washing station 88 with the following differences. For washing it is necessary to insure that the wash solution is removed from the reaction well 12. Pressurized inert gas is introduced though the dispensing nozzle 26 to flush the reaction chamber 74. To accomplish flushing the dispensing nozzle 26 is longer than for a regent delivery station in order to form a pressure tight seal with the inlet port 76 of the reaction well 12 during a flushing step. The longer dispensing nozzle 26 will normally interfere with the rotation of the carousel 10 and accordingly a suitable linear actuator for lifting the cartridge 100 is provided to move the dispensing nozzle out of interference to permit rotation of the carousel 10 and to lower the cartridge for a pressure tight seal between the dispensing nozzle 26 and the inlet port 76 of the reaction well 12. The Linear Actuator may comprise any apparatus that will lift the and lower the dispensing nozzle including, but not limited to solenoids, linear motors, motors with cam/lifter, motors with lead screw drive and the like.

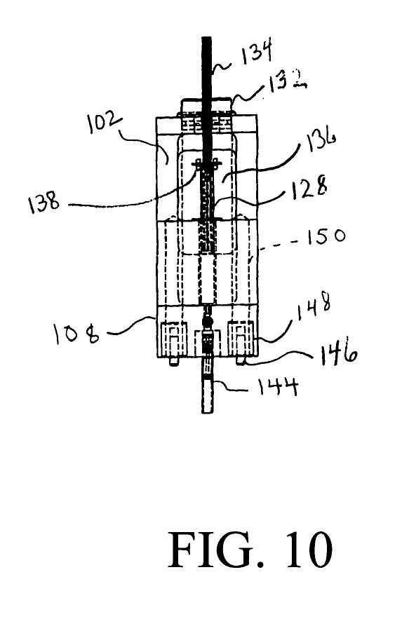

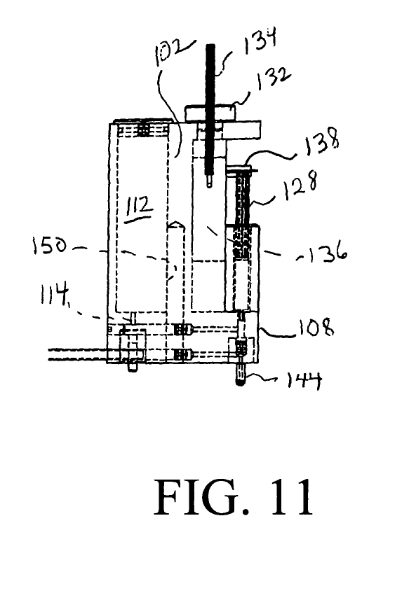

Referring to FIG. 10 and FIG. 11, where like reference numbers refer to like parts having like functions, a front and a side view of a cartridge 100 adapted for use as a washing station 88 is shown. The configuration and operation of the cartridge is as described above in connection with the cartridge of FIG. 8. Thus the reservoir 112 is defined by the front wall 102, the rear wall 106 and the bottom wall 108 and is normally sealed by the closure 114. The fluid port 118 communicates between the reservoir 112 and the fluid supply line 120. The operation of the syringe plunger 128 is responsive to the vertical movement of the plunger block 136 as driven by the lead screw 134 and linear motor 132. As described above the flange of the syringe plunger is disposed between the upper pair and the lower pair of fingers 138 for vertical movement with the plunger block 136.

As shown in the figures a dispensing nozzle 144 extends below the bottom wall 108 for a sealed fit in the inlet port 76 of the reaction well 12. To provide the necessary clearance for the rotation of the carousel 10, solenoids 146 are provided to raise the cartridge 100 so that the extended dispensing nozzle 144 is clear of the carousel 10. The solenoids 146 may be attached to the fixed platform 90 to act against the bottom wall 70 of the cartridge 100 or may be received in sockets 148 formed in the bottom wall. In either case guide pins (not shown) on the fixed platform 90 are received in pin sockets 150 formed in the front wall 101 of the cartridge 100 to provide positioning and to guide vertical motion during the lifting sequence. The pump controller is programmed to activate and deactivate the solenoids 146.

In operation a protocol consisting of a series of sequential steps for synthesizing a compound is input to the CPU 36 from the user interface 38 or is programmed in the CPU. Instructions from the CPU 36 are sent to the drive motor controller 32 which controls the rotation of the carousel 10. Depending on the particular protocol a reaction well 12 is rotated into alignment with a reagent delivery station 20. The pump controller 34 causes the linear motor 132 and plunger block 136 of the cartridge 100 of the reagent delivery station to fully depress and fully retract the syringe plunger 128 which produces a vacuum in the syringe 126 to draw the desired reagent from the reservoir 112 through the fluid port 118 and fluid supply line 120 into the syringe. The pump controller 34 reverses the vertical movement of the plunger block 136 and syringe plunger 128 to dispense the reagent through the dispensing nozzle 26 into the reaction chamber 74 of the reaction well 12. The sequence of rotation and dispensing steps are repeated until all of the reagents have been dispensed into the reaction chamber 74 of the reaction well 12. The need for an agitator to mix the reactants in the reaction well 12 is unnecessary. The elongated shape of the reaction chamber 74 coupled with rotation of the carousel 10, which rotates in either direction, agitates the fluids in the reaction wells to thoroughly mix the reactants. In addition to rotation during the sequence of steps called for by the protocol, the carousel can be programmed to use the drive motor 14 to agitate the reaction wells 12 with small cyclic motion at a user defined amplitude, duration and frequency.

As required during the reaction, the carousel 10 is rotated to align the reaction well 12 containing the reaction product with a cartridge 100 at a wash station 88. The cartridge 100 is normally in the raised position by the lifting action of the solenoids 146. The pump controller 146 deactivates the solenoids lowering the cartridge 100 which is guided by the guide pins in the pin sockets to bring the extended dispensing nozzle 144 into a tight fit in the inlet port 76 of the reaction well 12. In the case of a liquid reaction, high-pressure nitrogen, or suitable inert gas, is directed into the extended dispensing nozzle 144 to force the contents of the reaction well through the drain opening 80 for recovery of the contents. In the case of solid phase reactions, the pump controller 146 signals the linear motor 132 to cause the syringe plunger 128 to fully depress and retract to create a vacuum to draw wash fluid from the reservoir 112 of the cartridge 100. The linear motor 132 is then commanded to depress the syringe plunger 128 to force the wash fluid into the chamber 74 of the reaction well 12. Following this the flow of pressurized inert gas pressurizes the chamber 74 causing the valve 86 to open to flush the wash fluid from the reaction chamber through the drain opening 80 to the collection drain. The filter 84 in the filter housing 82 retains the solid phase products in the reaction chamber 74 for subsequent cleavage steps.

If a cleavage step is required the recovery container 94 may be attached to the reaction well 12 as described above. In the alternative, a separate vessel may be placed beneath the carousel 10 in alignment with the drain opening 80 of the reaction well 12 undergoing cleavage. Cleavage is carried out in accordance with well-understood procedures and in the same manner as the washing steps except that the cleavage fluid and finished product are recovered for subsequent separation steps.

While the cartridge 100 has been described herein as generally rectangular in shape, the particular shape of the cartridge is not critical. For example the cartridge 100 can be cylindrical with equally good results. The cartridges can be removably attached to the fixed platform 90 to provide flexibility in operation. Thus, simply replacing a cartridge containing one reagent for a cartridge containing a different reagent facilitates switching reagents according to different protocols. Removable cartridges also reduce waste of reagent and washing fluid since a cartridge can be returned to the synthesizer the next time a protocol calling for that reagent is carried out.

As described above the removable segments 48 allow for flexibility in the number of reaction wells 12 on the carousel 10. Depending on the diameter of the carousel 10 and the size of the reaction wells 12 there may conveniently be as many as 108 reaction wells and as few as one.

A scanner may be employed to identify the function, location and contents of each station. For example, a scanner may read an identifying bar code, a two dimensional pixel code, a color code and the like. Fluid level monitors such as Hall effect sensors, optical sensors or other conventionally available fluid sensors may be employed to determine fluid levels in the cartridge reservoirs 24. Means for heating or cooling the contents of the reaction well 12 can be provided, such as, for example, a thermoelectric peltier effect chiller, a resistive heating element or conductive fluid lines that circulate hot or cold fluid around the reaction wells 12 and the reservoir 112 of the cartridges 100. In addition to the delivery stations 20 and wash stations 88, one or more monitoring stations can be carried on the carousel for monitoring temperature, performing spectroscopic analysis of the contents of a reaction well 12, pH, purity of the product and the like.

From time to time it may be desired to carry out certain steps of a protocol on fewer than all of the reaction wells 12 on the carousel 10 or to perform certain procedures manually or on another synthesizer. In those situations the reaction wells 12 will define self contained reaction vessels that can be manipulated separately of the apparatus described herein.

As will be understood by those skilled in the art, various arrangements which lie within the spirit and scope of the invention other than those described in detail in the specification will occur to those persons skilled in the art. It is therefor to be understood that the invention is to be limited only by the claims appended hereto.

What is claimed is:

1. An automated chemical synthesizer comprising:
a. a housing having top, bottom and side walls defining a housing interior, a support member mounted in the housing interior;
b. a stationary delivery system carried by the support member, the stationary delivery system comprising one or more reagent delivery stations and one or more wash fluid delivery stations; and
c. a rotatable carousel carrying one or more reaction wells, the carousel being disposed under the stationary delivery system for rotatably and sequentially moving a reaction well into alignment with a reagent delivery station and a wash fluid delivery station for receiving therein one of a reactant and a wash fluid in accordance with the steps of a desired synthesis protocol.

2. The automated chemical synthesizer of claim 1 further comprising driving apparatus including a drive motor for driving the rotatable carousel.

3. The automated chemical synthesizer of claim 1 further comprising a control system including a central processing unit for receiving, storing and issuing the protocol commands and a drive motor controller for activating and deactivating the drive motor in accordance with the protocol commands.

4. The automated chemical synthesizer of claim 1 further comprising a drain system for the collection of spent reactants and wash fluid from the reaction wells.

5. The automated chemical synthesizer of claim 1 wherein the reaction well comprises a container having end walls, side walls, a bottom wall extending therebetween and a closure that cooperate to form a reaction chamber, an inlet port being provided in the closure for delivery of reactants to the reaction chamber, an outlet port in the bottom wall for removal of fluids.

6. The automated synthesizer of claim 5 wherein an end wall nearest the outlet port has a greater height than the opposite end wall and the bottom wall of the reaction well is downwardly biased from horizontal.

7. The automated chemical synthesizer of claim 6 wherein the bottom wall is biased downwardly from horizontal at an angle of between about 1° to about 45°.

8. The automated chemical synthesizer of claim 6 herein the bottom wall is downwardly biased from horizontal at an angle of between about 5° to about 10°.

9. The automated chemical synthesizer of claim 6 wherein the longitudinal dimension of the reaction well is greater than its transverse dimension and

10. The automated synthesizer of claim 9 wherein the reaction wells are oriented on the rotatable carousel with the longitudinal dimension normal to the axis of rotation of the rotatable carousel.

11. The automated synthesizer of claim 9 wherein the reaction wells are oriented on the rotatable carousel with the longitudinal dimension disposed at an angle to the axis of rotation of the carousel of between about 0° to about 90°

12. The automated synthesizer of claim 9 wherein the reaction wells are oriented on the rotatable carousel with the longitudinal dimension disposed at an angle to the axis of rotation of the carousel of between about 20° to about 30°.

13. The automated chemical synthesizer of claim 1 wherein the rotatable carousel comprises an annulus having one or more openings corresponding to the one or more reaction wells for fluid communication between a reaction well and the drain system.

14. The automated chemical synthesizer of claim 13 wherein one or more cavities are formed in the annulus, each cavity having a drain opening aligned with the corresponding opening in the annulus, each cavity being configured to removably receive a reaction well container.

15. The automated chemical synthesizer of claim 13 further including at least one arcuate segment removably attached to the annulus by a clamping bracket disposed on the annulus, the arcuate segment having formed thereon one or more cavities, a drain opening in each cavity aligned with a corresponding opening in the annulus, each cavity being configured to removably receive a reaction well container.

16. The automated chemical synthesizer of claim 13 further comprising an opposed pair of L-shaped brackets disposed on the undersurface of the annulus on opposite sides of at least one opening in the annulus, the horizontal arms of the brackets facing arms facing one another, a removable recovery container provided with a flange formed about its mouth is supported by the brackets and the flange with the mouth aligned with a corresponding opening for the collection of fluid from a reaction vessel.

17. The automated chemical synthesizer of claim 1 wherein the reagent delivery station comprises a cartridge having a front wall, side walls, a rear wall and a bottom wall and a top wall including a closure, each having an inner surface that cooperates to define a reservoir, the top, bottom and side walls are extended beyond the front wall to define a track for vertical movement of a plunger block therein, a lead screw is affixed at one end to the plunger block and a portion of the lead screw extending upwardly though an opening in the top wall, a bi-directional linear motor engages the extending portion of the lead screw to impart turns thereto for moving the plunger block vertically upwardly and downwardly in response to the turns of the lead screw, the extended bottom wall carrying an upwardly extending member having a through running bore that is aligned with the track for the plunger block for receiving a syringe and syringe plunger, a flange formed on the upper end of the syringe plunger is received between upper and lower pairs of fingers on the plunger block that act against the flange to raise and lower the syringe plunger responsive to the upward and downward movement of the plunger block, a fluid port in the bottom wall communicates between the reservoir and a fluid supply line that extends through the bottom wall to a fluid dispensing line that communicates between the syringe and a dispensing nozzle formed on the bottom wall.

18. The automated chemical synthesizer of claim 17 wherein the control system further includes a pump controller, the linear motor being in electrical communication with the pump controller for control of the vertical movement of the plunger block and resultant operation of the syringe.

19. The automated chemical synthesizer of claim 17 wherein an inert gas supply line extends through the bottom wall for communication between a source of inert gas, the fluid dispensing line and the dispensing nozzle for introduction of an inert gas into a reaction chamber.

20. The automated chemical synthesizer of claim 1 wherein the wash fluid delivery station comprises a cartridge having a front wall, side walls, a rear wall and a bottom wall and a top wall including a closure, each having an inner surface that cooperates to define a reservoir, the top, bottom and side walls are extended beyond the front wall to define a track for vertical movement of a plunger block therein, a lead screw is affixed at one end to the plunger block and a portion of the lead screw extends upwardly though an opening in the top wall, a bi-directional linear motor engages the extending portion of the lead screw to impart turns thereto to move the plunger block vertically upwardly and downwardly, the extended bottom wall carries an upwardly extending member having a through running bore that is aligned with the track for the plunger block for receiving a syringe and syringe plunger, a flange formed on the upper end of the syringe plunger is received between upper and lower pairs of fingers on the plunger block that act against the flange to raise and lower the syringe plunger responsive to the upward and downward movement of the plunger block, a fluid port in the bottom wall communicates between the reservoir and a fluid supply line that extends through the bottom wall to a fluid dispensing line that communicates between the syringe and a dispensing nozzle formed on the bottom wall.

21. The automated chemical synthesizer of claim 20 wherein the wash fluid delivery station further comprises a linear activator for raising the cartridge to move the dispensing nozzle into a non-interfering position to permit rotation of the carousel and to lower the cartridge for a pressure tight seal between the dispensing nozzle and the inlet port of a reaction well.

22. The automated chemical synthesizer of claim 2 wherein a fluid recovery container is removably attached to the bottom wall of the reaction well for recovery of fluids containing the reaction product of a solid phase reaction.

23. An automated chemical synthesizer comprising a stationary delivery system comprising one or more reagent delivery stations and one or more wash fluid delivery stations and a rotatable carousel carrying one or more reaction wells, the carousel being disposed under the stationary delivery system for rotatably and sequentially moving a reaction well into alignment with a reagent delivery station and a wash fluid delivery station for receiving therein one of a reactant and a wash fluid in accordance with the steps of a desired synthesis protocol.

24. A container for conducting a chemical reaction capable of use as a stand alone reaction well or as part of a synthesizer, the container comprising end walls, side walls, a bottom wall and a closure that cooperate to form a reaction chamber, an inlet port being provided in the closure for delivery of reactants to the reaction chamber, an outlet port in the bottom wall for removal of fluids.

25. The container of claim 24 wherein the end wall nearest the outlet port has a greater height than the opposite end wall and the bottom wall of the reaction well is downwardly biased from horizontal toward the outlet port.

26. The container of claim 25 wherein the bottom wall is downwardly biased from horizontal at an angle of between about 1° to about 45°.

27. The container of claim 26 wherein the bottom wall is downwardly biased from horizontal at an angle of between about 5° to about 10°.
